(19) United States
(12) Patent Application Publication
(10) Pub. No.: US 2007/0192151 A1
(43) Pub. Date: Aug. 16, 2007

(54) Data analysis and visualization method

(76) Inventors: William Derek Finley, Ottawa (CA); Christopher William Doylend, Ottawa (CA); Gordon Freedman, Nepean (CA)

Correspondence Address: FREEDMAN & ASSOCIATES, 117 CENTREPOINTE DRIVE, SUITE 350, NEPEAN, ONTARIO, K2G 5X3, omitted

(21) Appl. No.: 11/698,959

(22) Filed: Jan. 29, 2007

Related U.S. Application Data
(60) Provisional application No. 60/762,514, filed on Jan. 27, 2006.

(51) Int. Cl. G06F 17/50

(52) U.S. Cl. 705/7

(57) ABSTRACT

Analyzing data relating to an organization is performed by defining interconnections between data nodes belonging to a first organizational chart of the organization and data nodes belonging to a second organizational chart of the organization. Typically, the defined interconnections are for correlating the first organizational chart and the second organizational chart in three-dimensions so as to provide a three-dimensional data visualization structure of the organization. Data relating to the organization is mapped onto the three-dimensional data visualization structure using a predetermined process. The mapped data is then correlated against known template data having a relation to categories of organizational structure. Finally, data indicative of the category of the organizational structure is provided.

This application claims the benefit of U.S. Provisional Application No. 60/762,514, filed on Jan. 27, 2006, the entire contents of which are incorporated herein by reference.

### FIELD OF THE INVENTION

The present invention relates generally to data analysis, and more particularly to a method of analyzing and visualizing correlative data in three dimensions.

### BACKGROUND

Data storage, analysis, retrieval and display have always been important aspects of computers. Although different data retrieval and data display models have been proposed over the years, most system designers return to one of three models due to their simplicity, ease of use, and user comprehensibility. These three models include the desktop model, the list based model, and the hierarchical list model.

The desktop model was popularized by Apple® with its Macintosh® computers, and is used to display computer operating system data in a virtual desktop environment. On a computer screen is shown an image of a two-dimensional desktop with files, folders, a trashcan, and so forth being represented by different icons that are arranged in some manner on the “surface” of the desktop. To access files that are stored on the computer system, a user simply selects an appropriate icon from the desktop display. Though the desktop model is convenient and intuitive, it is often difficult to implement due to system level constraints. For example, the Windows® operating system that is provided by Microsoft® Corporation has limitations on file name length and, as such, is sometimes unable to store files sufficiently deeply within nested folders to truly reflect the desktop based model. Further, since some systems are more limited than others, the model when implemented results in some limitations on portability. For many applications and for application execution, the desktop model is often poor.

Also, though the desktop model is well suited to providing user references for many different functions, it is poorly suited for organizing large volumes of data since it has no inherent organizational structure other than the one that is set by a user. Thus, similar to actual physical desktops, some virtual desktops are neat and organized while others are messy and disorganized. Thus, for data organization and retrieval, the virtual desktop model is often neutral—neither enhancing nor diminishing a user's organizational skills.

The list-based model is employed in all aspects of daily life. Music organization programs display music identifiers such as titles and artists in a list that is sortable and searchable based on many different criteria. Typically, sort criteria are displayed as column headers allowing for easy searching based on the column headers. Many applications support more varied search criteria and search definition.

Another example of list based data display is Internet search engines, which typically show a list of results for a provided search query. The results are then selectable for navigating to a World Wide Web Site relating to the listed result. Unfortunately, with the wide adoption of the World Wide Web and with significant attempts to get around search engine technology—to “fool” the search engines—it is often difficult to significantly reduce a search space given a particular query. For example, the search term “fingerprint” returns a significant number of results for biometric based fingerprinting similar to that used by police and a significant number of results for genetic fingerprinting using DNA. These results are distinct one from another.

The hierarchical list is similar to the list-based model but for each element within a higher-level list, there exist further sub-items at a lower level. Thus, a first set of folders allows for selection of a folder having within it a set of subfolders, etc. This allows for effective organization of listed data. In the above noted music list program example, classical music can be stored in a separate sub list from country music, etc.

Some complex data structures, such as for instance the organizational charts of large corporations, or of other similarly organized bodies such as for instance government or military units, consist of interconnected and highly correlated nodes. For instance, hierarchal organization charts of a large corporation may include a separate chart for each different unit of the corporation, with individuals and/or departments in each unit being represented as separate nodes in the chart, and with relationships between the separate nodes in the chart being shown as interconnections in two-dimensions. That said, it is often the case that relationships exist between individuals and/or departments in different units of the corporation, and accordingly the nodes of one chart actually are interconnected with the nodes of one or more of the other charts. Furthermore, it is often the case that different types of relationships exist between the nodes, such as for instance reporting relationships, communication relationships, financial relationships, etc. Unfortunately, current methods for analyzing and visualizing such highly correlated sets of data do not produce results that are intuitive to the user, and as a result the analysis is cumbersome and prone to errors and the visualization is confusing and prone to omissions.

It would be advantageous to provide a method for analyzing and/or visualizing highly correlated data sets that overcomes at least some of the above-mentioned limitations of the prior art.

### SUMMARY OF EMBODIMENTS OF THE INSTANT INVENTION

According to an aspect of the instant invention there is provided a method of analyzing data relating to an organization, comprising; defining interconnections between data nodes belonging to a first organizational chart of the organization and data nodes belonging to a second organizational chart of the organization, the defined interconnections for correlating the first organizational chart and the second organizational chart in three-dimensions so as to provide a three-dimensional data visualization structure of the organization; mapping data relating to the organization onto the three-dimensional data visualization structure using a predetermined process; correlating the mapped data against known template data having a relation to categories of organizational structure; and, providing data indicative of the category of the organizational structure.

In accordance with another embodiment of the instant invention there is provided a method of analyzing data relating to an organization, comprising; providing a three-dimensional data visualization structure of the organization, the three-dimensional data visualization structure comprising N organizational charts distributed on a surface of a three-dimensional shape, each one of the N organizational charts comprising a plurality of data nodes, and at least some of the plurality of data nodes in each one of the N organizational charts being interconnected with a data node in another one of the N organizational charts; mapping data relating to the organization onto the three-dimensional data visualization structure, the data relating to an attribute of one of the data nodes in one of the N organizational charts; updating attributes of data nodes in any of the N organizational charts that are interconnected with the one of the data nodes; and, displaying the three-dimensional data visualization structure with updated attributes for being viewed by a user.

In accordance with another aspect of the instant invention there is provided a computer-readable storage medium having stored thereon computer-executable instructions for performing a method of analyzing data relating to an organization, the method comprising: defining interconnections between data nodes belonging to a first organizational chart of the organization and data nodes belonging to a second organizational chart of the organization, the defined interconnections for correlating the first organizational chart and the second organizational chart in three-dimensions so as to provide a three-dimensional data visualization structure of the organization; mapping data relating to the organization onto the three-dimensional data visualization structure using a predetermined process; correlating the mapped data against known template data having a relation to categories of organizational structure; and, providing data indicative of the category of the organizational structure.

### BRIEF DESCRIPTION OF THE DRAWINGS

Exemplary embodiments of the invention will now be described in conjunction with the following drawings, in which similar reference numerals designate similar items:

FIG. 1 shows a simplified diagram of a three-dimensional data visualization structure in accordance with an embodiment of the instant invention;

FIG. 2 shows the three-dimensional data visualization structure of FIG. 1 after rotation;

FIG. 3 is a simplified schematic of an embodiment of the invention wherein the organization chart of an organization is displayed with overlays for management reporting as well as project reporting;

FIG. 4 is a simplified flow diagram for a method of analyzing data relating to an organization according to an embodiment of the instant invention; and,

FIG. 5 is a simplified flow diagram for a method of analyzing data relating to an organization according to another embodiment of the instant invention.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and the scope of the invention. Thus, the present invention is not intended to be limited to the embodiments disclosed, but is to be accorded the widest scope consistent with the principles and features disclosed herein.

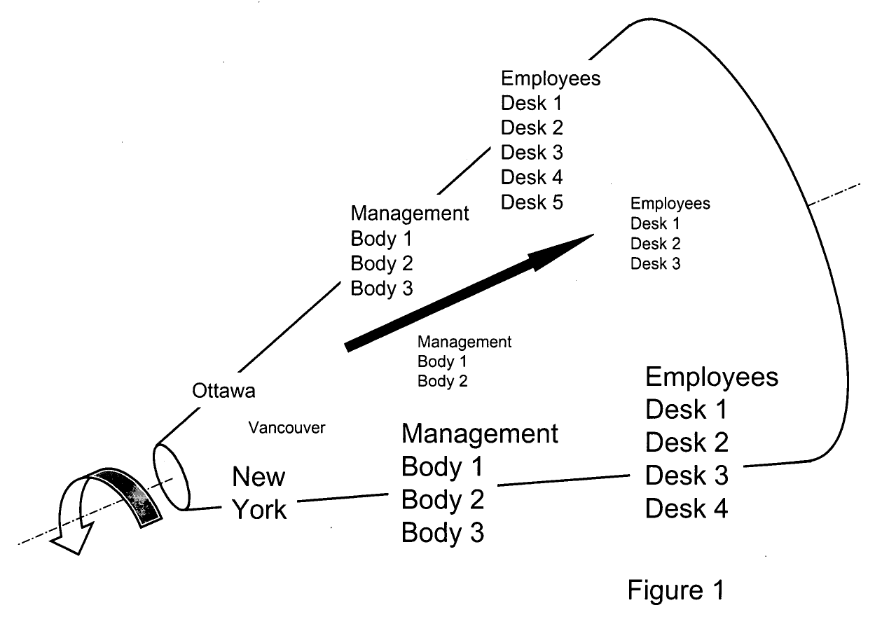

Referring to FIG. 1, shown is a three dimensional listing of organizational chart data relating to a corporation, or to another similarly organized body such as for instance a government department, a military unit, an aid agency, an educational institution, a retail chain, a transportation system, a volunteer association, a parts list, a manufacturers process, a patent, a supplier contract, a software application, etc. Any such organized body is referred to hereinafter simply as “the organization,” and the organizational charts associated therewith are referred to simply as “org charts.” In FIG. 1 the data is shown distributed on a surface of a three-dimensional cone for simplicity of discussion, though of course any of a number of other three-dimensional representations optionally is supported. For instance, optionally the three dimensional structure of the data being presented is spherical, a surface of a sphere, cubic, a surface of a cube, or is placed in accordance with another algorithm, manually, or randomly within a three dimensional or hierarchical three-dimensional space.

The org chart data that is shown in FIG. 1 represents a reporting org chart for the organization, or optionally for a portion thereof. In the instant example the data is sorted by office location (New York, Ottawa and Vancouver) around the cone and by hierarchal order within each office along a linear axis of the cone. Further, the New York office location is shown at the front of the cone (nearest the user) and the Vancouver office location is shown at the back of the cone (away from the user) with the Ottawa office location being shown at a position intermediate the New York and Vancouver office locations. As will be apparent, the size of the text font in FIG. 1 serves the purpose of providing a three-dimensional perspective, with text that is positioned closest to the user being the largest and text that is farthest away from the user being the smallest.

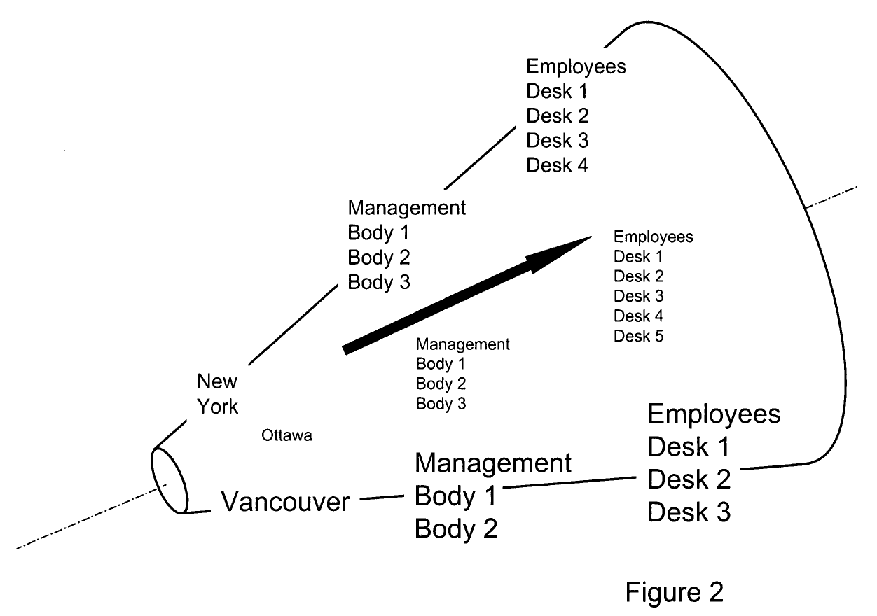

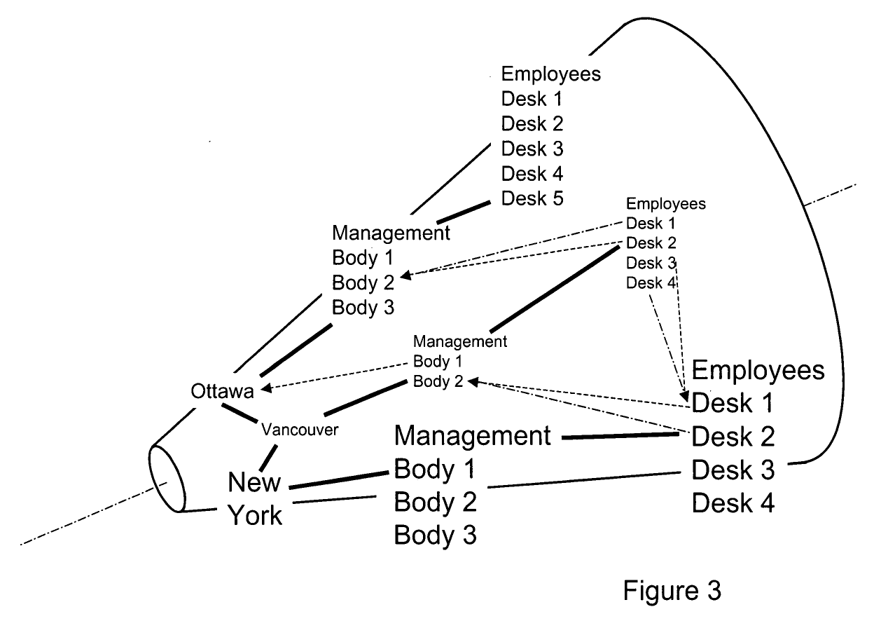

Due to the size of the organization, it is advantageous to utilize a three-dimensional data representation model in order to support convenient visualization of interconnections for reporting purposes, etc. Advantageously, the org chart so presented allows for moving of individuals within the organization. Furthermore, the org chart data may be manipulated—rotated or traversed—to identify correlated data according to a user perspective. So for example, rotation of the cone in the direction that is shown in FIG. 1 brings the Vancouver office location forward as is shown in FIG. 2. The user may optionally “drill in” or “drill out” to display other data that is correlated with any of the data shown in FIG. 2. Preferably, a process for coupling and decoupling of elements within the three dimensional view is provided for grouping of elements or for entering correlative data relating to different elements. Further preferably, viewing processes include navigation tools for rotating, translating, and navigating the three-dimensional view space.
Referring to FIG. 3, shown is another three-dimensional listing of org chart data, highlighting a plurality of different interconnections including those of a communication org chart represented by dashed lines, those of a reporting org chart represented by solid lines and those of a project org chart represented by dotted lines. Here, reporting is performed on a functional basis, projects on a product basis, and communication via the legal, human resources, and communications departments. The different interconnects are shown between different slices of the organization. Each slice is presented as a reporting org chart with the other org charts represented as interconnects between slices. By moving the slices, interconnections are both visible and more easily comprehended. Advantageously, a plurality of overlaid org charts provides many advantages. Firstly, corporate reorganizations are more easily viewed since, most often, they affect only reporting while retaining all other aspects of an organization. Secondly, managing information flow within an organization is facilitated since its flow for each distinct purpose is now mappable. Thirdly, by attributing to the interconnections rules, simulation of events and actual analysis of real events—business information analysis—become a real possibility.

Another form of org chart (not shown) relates to finances. These include financial reporting charts, revenue flow charts, cost propagation charts, financial approval org charts, and cash propagation charts for cash based businesses. By overlaying these on org charts and information charts, the amount of analysis performable increases dramatically while the visual nature of the chart remains functionally useful. Further, when the user is provided an opportunity to move blocks within the three-dimensional viewing space, it is possible to isolate blocks or groups of blocks while maintaining the rest of the organization. For example, a slice view of an organization of the information flow therethrough is provided. By moving some blocks, an additional slice is created for analysis, blocks within the slice relating to something being analyzed.

In each of the above examples interconnections are defined for correlating different org charts in three-dimensions, so as to provide a three-dimensional data visualization structure of the organization. Advantageously, the user may also define rules within the three-dimensional structure, such that data can traverse the three-dimensional structure in accordance with those rules. Thereafter, when data is mapped onto the three-dimensional structure the rules are applied such that the data “flows” through the organization.

One useful application, which is provided hereinbelow as a non-limiting example, relates to determining the corporate structure of very large corporate entities. Due to their size, distributed nature, and diversification across multiple brands, services and/or product lines, very large corporate entities tend to be difficult to analyze. Furthermore, it is often the case that the actual corporate structure is different than the intended corporate structure. In such cases, the management practices that are being employed may not be suitable in view of the actual corporate structure.

Such structural analysis, based on the entire organization, includes mapping data onto the three-dimensional data visualization structure of the organization using a predetermined mapping algorithm, and then correlating the mapped data against known template data having a relation to categories of organizational structure. Correlation with the known template data must match to within predetermined norms, which defines the category. Once the category of organizational structure has been identified, then practices that are appropriate for the identified structure may be applied. For instance, academics, economists and statisticians study different corporate structures and develop a body of knowledge relating to the problems that are associated with certain corporate structure, etc. Alternatively, problems within the organization may be identified once the actual corporate structure is determined, based on known corporate structures that lead to problems.

Advantageously, at least one embodiment of the instant invention allows determination of the actual type or category of organizational structure based on the entire organization, not just based on the way the top layer of the organization is set up so as to try to achieve a certain structure. The determination is based on global generalizations, the big picture items, the bigger trends, etc.

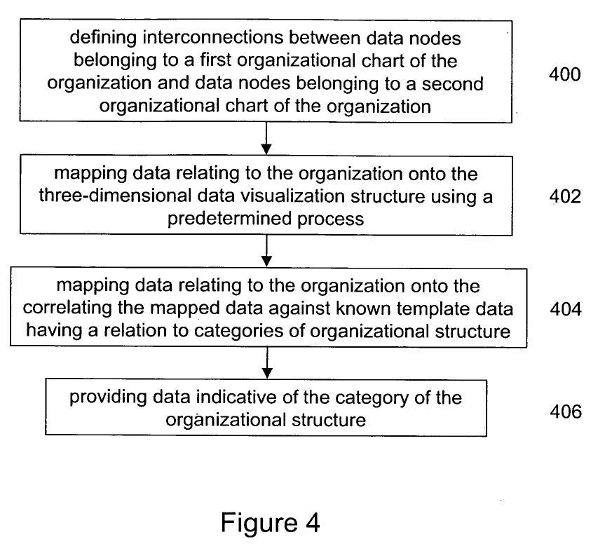

Referring now to FIG. 4, shown is a simplified flow diagram for a method of analyzing data relating to an organization according to an embodiment of the instant invention. At step 400 interconnections are defined between data nodes belonging to a first organizational chart of the organization and data nodes belonging to a second organizational chart of the organization. The defined interconnections are for correlating the first organizational chart and the second organizational chart in three-dimensions, so as to provide a three-dimensional data visualization structure of the organization. At step 402 data relating to the organization is mapped onto the three-dimensional data visualization structure using a predetermined process. At step 404 the mapped data is correlated against known template data, the known template data having a relation to categories of organizational structure. At step 406 data indicative of the category of the organizational structure is provided.

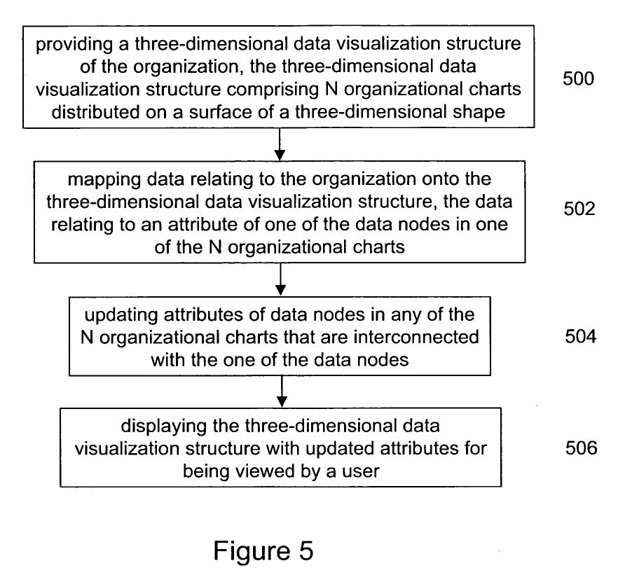

Referring now to FIG. 5, shown is a simplified flow diagram for a method of analyzing data relating to an organization according to another embodiment of the instant invention. At step 500 a three-dimensional data visualization structure of the organization is provided. In particular, the three-dimensional data visualization structure comprising N organizational charts distributed on a surface of a three-dimensional solid shape, each one of the N organizational charts comprising a plurality of data nodes, and at least some of the plurality of data nodes in each one of the N organizational charts being interconnected with a data node in another one of the N organizational charts. At step 502 data relating to the organization is mapped onto the three-dimensional data visualization structure, the data relating to an attribute of one of the data nodes in one of the N organizational charts. At step 504 attributes are updated for data nodes in any of the N organizational charts that are interconnected with the one of the data nodes. At step 506 the three-dimensional data visualization structure with updated attributes is displayed for being viewed by a user. According to this method, an attribute is defined as non organizational-structure related data. For instance, the attribute may relate to a financial value such as sales volume or billing amount, or it may relate to an efficiency value or another similar measure.

Of course, while the above example makes reference specifically to corporate structure of an organization, the same general principles may also be applied to other organized bodies for which many different parameters result in a multi-dimensional mapping of the data into a space, such mapping being useful in classifying the data. 100331 Optionally, the same general principles are applied directly to financial data, for instance, rather than structural organizational data. In such a case, the financial data is mapped into a three-dimensional report structure which is indicative of, for example, good new, bad news, stock going up or down, embezzlement within a unit, etc. Appropriate courses of action then are selected in dependence upon the category of the results.

There are many processes for correlating map data. For example, the map data is correlatable as a whole data set. Alternatively, it is correlated in groups or segments. For example, this is performed iteratively. Further alternatively, it is correlated recursively to correlate all organizations and all sub-organizations for which template data exists. Further alternatively, only areas for which corrective suggestions are known are correlated with the organizational structure. Thus, organizational structures that are known to be correctable, improvable, need monitoring, or have other suggestions relating thereto are identified and indicated.

Numerous other embodiments may be envisioned without departing from the spirit and scope of the invention.

What is claimed is:

1. A method of analyzing data relating to an organization, comprising;
defining interconnections between data nodes belonging to a first organizational chart of the organization and data nodes belonging to a second organizational chart of the organization, the defined interconnections for correlating the first organizational chart and the second organizational chart in three-dimensions so as to provide a three-dimensional data visualization structure of the organization;
mapping data relating to the organization onto the three-dimensional data visualization structure using a predetermined process;
correlating the mapped data against known template data having a relation to categories of organizational structure; and,
providing data indicative of the category of the organizational structure.

2. A method according to claim 1, comprising displaying the three-dimensional data visualization structure with mapped data overlaid thereupon for being viewed by a user.

3. A method according to claim 1, wherein correlating comprises correlating portions of the mapped data with template data to identify within an organization patterns of organization.

4. A method according to claim 3 wherein correlating is performed iteratively to identify a set of organization patterns.

5. A method according to claim 3 wherein correlating is performed recursively to identify a set of organization patterns.

6. A method according to claim 1, wherein correlating comprises correlating portions of the mapped data with template data in a time varying fashion to identify within the organization trends.

7. A method according to claim 6 wherein correlating is performed iteratively to identify a set of organizational trends.

8. A method according to claim 6 wherein correlating is performed recursively to identify a set of organizational trends.

9. A method according to claim 1 wherein the template data relates to known organizational categories and a suggested course of action and comprising: providing an indication of the suggested course of action for each identified category.

10. A method of analyzing data relating to an organization, comprising;
providing a three-dimensional data visualization structure of the organization, the three-dimensional data visualization structure comprising N organizational charts distributed on a surface of a three-dimensional shape, each one of the N organizational charts comprising a plurality of data nodes, and at least some of the plurality of data nodes in each one of the N organizational charts being interconnected with a data node in another one of the N organizational charts;
mapping data relating to the organization onto the three-dimensional data visualization structure, the data relating to an attribute of one of the data nodes in one of the N organizational charts;
updating attributes of data nodes in any of the N organizational charts that are interconnected with the one of the data nodes; and,
displaying the three-dimensional data visualization structure with updated attributes for being viewed by a user.

11. A method according to claim 10, wherein the attribute relates to other than organizational-structure related data.

12. A method according to claim 10, comprising displaying the three-dimensional data visualization structure with mapped data overlaid thereupon for being viewed by a user.

13. A method according to claim 10, comprising: correlating portions of the mapped data with template data to identify within an organization patterns of organization.

14. A method according to claim 13 comprising: correlating attribute data within the identified organization patterns.

15. A method according to claim 14, wherein correlating comprises correlating the portions of the mapped data with the template data in a time varying fashion to identify within the organization trends.

16. A method according to claim 15 wherein the template data relates to known organizational categories and known attribute values within those known organizational categories and a suggested course of action and comprising: providing an indication of the suggested course of action for each identified category.

17. A method according to claim 13 wherein the template data relates to known organizational categories and a suggested course of action and comprising: providing an indication of the suggested course of action for each identified category.

18. A computer-readable storage medium having stored thereon computer-executable instructions for performing a method of analyzing data relating to an organization, the method comprising:
defining interconnections between data nodes belonging to a first organizational chart of the organization and data nodes belonging to a second organizational chart of the organization, the defined interconnections for correlating the first organizational chart and the second organizational chart in three-dimensions so as to provide a three-dimensional data visualization structure of the organization;
mapping data relating to the organization onto the three-dimensional data visualization structure using a predetermined process;
correlating the mapped data against known template data having a relation to categories of organizational structure; and,
providing data indicative of the category of the organizational structure.
